(19) United States
(12) Patent Application Publication
(10) Pub. No.: US 2024/0203410 A1
(43) Pub. Date: Jun. 20, 2024

(54) ADAPTING VIRTUAL FEATURES OF A VIRTUAL ENVIRONMENT FOR STREAMLINING ASSISTANT INTERACTIONS IN THE VIRTUAL ENVIRONMENT

(71) Applicant: GOOGLE LLC, Mountain View, CA (US)

(72) Inventors: Victor Carbune, Zurich (CH); Matthew Sharifi, Kilchberg (CH)

(21) Appl. No.: 18/081,557

(22) Filed: Dec. 14, 2022

(51) Int. Cl. G10L 15/22; G06F 3/16; G06T 17/00; G06V 10/74

(52) U.S. Cl. CPC G10L 15/22; G06F 3/167; G06T 17/00; G06V 10/761; G10L 2015/223

(57) ABSTRACT

Implementations set forth herein relate to an automated assistant application that can be accessible via a virtual environment and can streamline certain assistant interactions by rendering certain virtual features within the virtual environment. When the automated assistant determines that a user is accessing a portion of a virtual environment that includes a particular virtual object, the automated assistant can identify application operations that may be associated with the particular virtual object. Based on these identified operations, the automated assistant can cause rendering of certain virtual features in the virtual environment for initializing and/or otherwise controlling the operations. In some instances, these operations can affect the virtual environment and/or devices in a physical environment, as well as any other users that may be accessing the virtual environment. Virtual features can thereafter be adapted, by the automated assistant, to streamline interactions that a user may be repeatedly occurring.

### BACKGROUND

Humans may engage in human-to-computer dialogs with interactive software applications referred to herein as “automated assistants” (also referred to as “digital agents,” “chatbots,” “interactive personal assistants,” “intelligent personal assistants,” “assistant applications,” “conversational agents,” etc.). For example, humans (which when they interact with automated assistants may be referred to as “users”) may provide commands and/or requests to an automated assistant using spoken natural language input (i.e., utterances), which may in some cases be converted into text and then processed, and/or by providing textual (e.g., typed) natural language input.

In some instances, a virtual environment can be available to users who also employ an automated assistant in a physical environment, such as their home or office. The virtual environment may be used to facilitate interactions between users, such as co-workers, that wish to meet in virtual spaces to more effectively discuss certain topics. However, when a user is engaged with a virtual environment, the user may have limited or no access to their automated assistant. As a result, a user may have to handle certain tasks in the virtual environment without the automated assistant, which may cause certain tasks to be performed inefficiently. For example, tasks such as turning on lights in a virtual room, placing a phone call, and/or rendering a presentation may need to be performed as a series of inputs to a virtual environment application, whereas, in a physical environment, such tasks could be initialized by a spoken utterance to the automated assistant. Omitting such efficiencies in the virtual environment can result in power consumption and reduced computational bandwidth at any affected computing devices—especially in circumstances when other users may be waiting for a user to complete certain tasks.

### SUMMARY

Implementations set forth herein relate to an automated assistant that can be responsive to user interactions occurring in a virtual environment between the user and various virtual objects that may not be rendered by an automated assistant application. The automated assistant can determine how the user is interacting with the virtual environment using an application programming interface (API) and/or any other software interface. For example, the user can be accessing the virtual environment using wearable virtual reality (VR) headset, computerized glasses, and/or any other device for viewing a virtual environment. An entity that provides the virtual environment can be separate from another entity that provides the automated assistant and one or more other entities that facilitate certain experiences within the virtual environment. For instance, a music application provider can interact with the virtual environment to provide certain virtual music objects (e.g., a virtual record player) to be included in the virtual environment for controlling playback of music for any users that are located (per their respective avatar that represents a position of the user within the virtual environment) near the virtual music object. In some implementations, the automated assistant can determine that a user is interacting with the virtual music object via an avatar in the virtual environment, and can, in response, operate to facilitate “warm” word and/or “hot” word commands for controlling the virtual music object.

For example, when the user is not accessing the virtual environment, the user may solicit the automated assistant play music using a particular streaming service by providing a spoken utterance, such as, “Assistant, play music with XYZ Streaming App,” to a standalone speaker device in a physical environment such as their home. The entity that provides the XYZ streaming application can also provide certain virtual objects in another entity's virtual environment, such as a virtual record player object. In some implementations, the virtual objects provided by a particular entity can be identified by virtual characteristics of the virtual object that are also associated with the particular entity, such a logo, a sound, graphic, and/or other user-identifiable characteristic. The automated assistant can then determine that a user is interacting with the virtual object, or is estimated to interact with the virtual object, and fulfill certain requests from the user accordingly. For example, when the user is viewing an area of a virtual room that includes the virtual music object, and the user provides a spoken utterance such as, “Assistant, play music,” the automated assistant can determine that the virtual object is associated with the XYZ streaming application and render audio using the XYZ streaming application. In other words, because the virtual object of the XYZ streaming application is located near an avatar of the user when the user provides the spoken utterance, the automated assistant can assume certain parameters for operations for fulfilling the request from the user, such as the application (e.g., the XYZ streaming application) for fulfilling the request.

In some implementations, the automated assistant can cause virtual features of virtual objects, and/or virtual objects themselves, to be created according to how a user interacts with the virtual environment, virtual objects, and/or applications in or out of the virtual environment. For example, when a user that frequently interacts with a virtual word processing object (e.g., a virtual typewriter from an entity that provides a word processing application) to create a document having a particular template (e.g., a time sheet for the week), the automated assistant can generate a virtual feature to be included at or near the virtual word processing object. The virtual feature can be, but is not limited to, a virtual button on the virtual object, textual content displayed on the virtual object (e.g., text indicating a “warm” or “hot” word), and/or any other indication that the user can provide an input to the automated assistant to invoke a shortcut for streamlining execution of one or more operations. For example, the virtual feature for creating the document from the template can be a virtual button on the virtual typewriter with a label such as, “Document Template” or “Timesheet.” In some implementations, textual content on a virtual feature can be spoken by the user while the user is viewing the virtual environment to initialize one or more operations corresponding to the virtual feature. Alternatively, the user can cause their avatar to tap the virtual button to initialize the execution of the operation. For example, when an avatar for the user is within a threshold distance from, or viewing, the virtual feature and/or the virtual object, the user can provide a spoken utterance such as, “Timesheet,” or tap the virtual button. In response, the automated assistant can initialize the word processing application associated with the virtual typewriter and cause a document to be created using the particular document template.

In some implementations, the automated assistant can render indications of operations and/or routines that the user can control by interacting with certain virtual objects and/or virtual features while accessing the virtual environment. For example, a user that is interacting with the automated assistant in a physical environment, such as their kitchen, can provide the automated assistant with a spoken utterance such as, “Assistant, good morning.” The phrase, “good morning,” can correspond to an assistant routine that, when executed by the automated assistant, causes the automated assistant to unmute the user's cellular phone, play the local news on a nearby audio device, and thereafter play a “morning” radio station on their streaming application. The automated assistant can process contextual data when the user is accessing the virtual environment to determine when the user is accessing a virtual kitchen in the virtual environment in the morning and cause the “routine” to be represented as a virtual feature of a virtual object in the virtual environment. For example, a virtual kitchen appliance, such as a stove provided by a separate entity, can be appended with a virtual feature that indicates the user can initiate the “good morning” routine by interacting with the virtual feature. The virtual feature can be appended to the virtual kitchen appliance, with prior permission from the separate entity and the user. For example, the virtual feature can include text on a virtual surface of the virtual kitchen appliance and/or a virtual interface that can be selected with a virtual tap and/or other virtual gesture (e.g., causing a virtual avatar to point at the virtual interface).

In response to receiving a selection of the virtual feature, the automated assistant can cause the corresponding operations to be initialized in the virtual environment and/or in a physical environment of the user. In some implementations, the automated assistant can respond to the user according to a context of the user in the physical environment and/or in the virtual environment. Alternatively, or additionally, the automated assistant can respond according to whether certain operations can be performed exclusively in the physical environment or exclusively in the virtual environment. For example, in response to the user selecting the virtual feature for the “good morning” routine in the virtual environment, the automated assistant can unmute the cellular phone of the user in the physical environment. Additionally, the automated assistant can cause a virtual audio device (e.g., a virtual boombox) to render the local news, which can be rendered for the user via an audio interface of the computing device through which the user is accessing the virtual environment. In such instances, when other avatars for other users are present near the virtual audio device, the other users can also hear the local news broadcasted through their respective computing devices. Optionally, the other users may not be able to see the same virtual features that the user can see, unless the user provides express permission for other users to utilize their routines. For example, another user may be provided permission to access to the virtual feature and, in response to the other user selecting the virtual feature, the other user's cellular phone can be unmuted and the local news, for the other user's geographic area, can be broadcast in the virtual environment for nearby user avatars to hear.

The above description is provided as an overview of some implementations of the present disclosure. Further description of those implementations, and other implementations, are described in more detail below.

Other implementations may include a non-transitory computer readable storage medium storing instructions executable by one or more processors (e.g., central processing unit(s) (CPU(s)), graphics processing unit(s) (GPU(s)), and/or tensor processing unit(s) (TPU(s)) to perform a method such as one or more of the methods described above and/or elsewhere herein. Yet other implementations may include a system of one or more computers that include one or more processors operable to execute stored instructions to perform a method such as one or more of the methods described above and/or elsewhere herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1A, FIG. 1B, FIG. 1C, and FIG. 1D illustrate views of a user interacting with an automated assistant application that can be responsive to virtual feature interactions while the user is accessing a virtual environment.

FIG. 2 illustrates a system for providing an automated assistant that can be responsive to a user that is accessing a virtual environment and can render virtual features in the virtual environment for facilitating further interactions with the automated assistant.

FIG. 3 illustrates a method for providing a virtual feature for a virtual environment for controlling an operation of an automated assistant application and/or another application.

FIG. 4 is a block diagram of an example computer system

### DETAILED DESCRIPTION

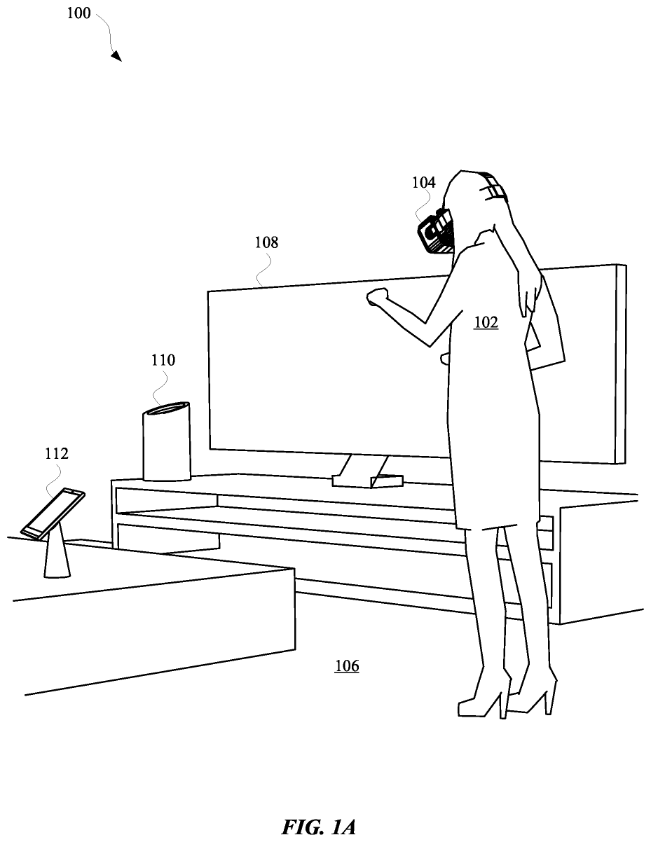

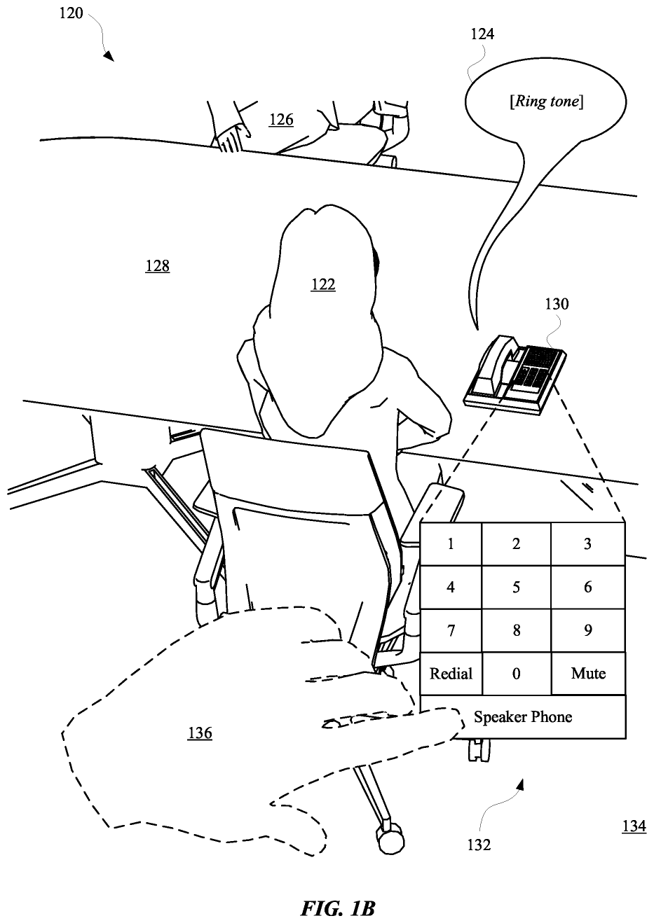

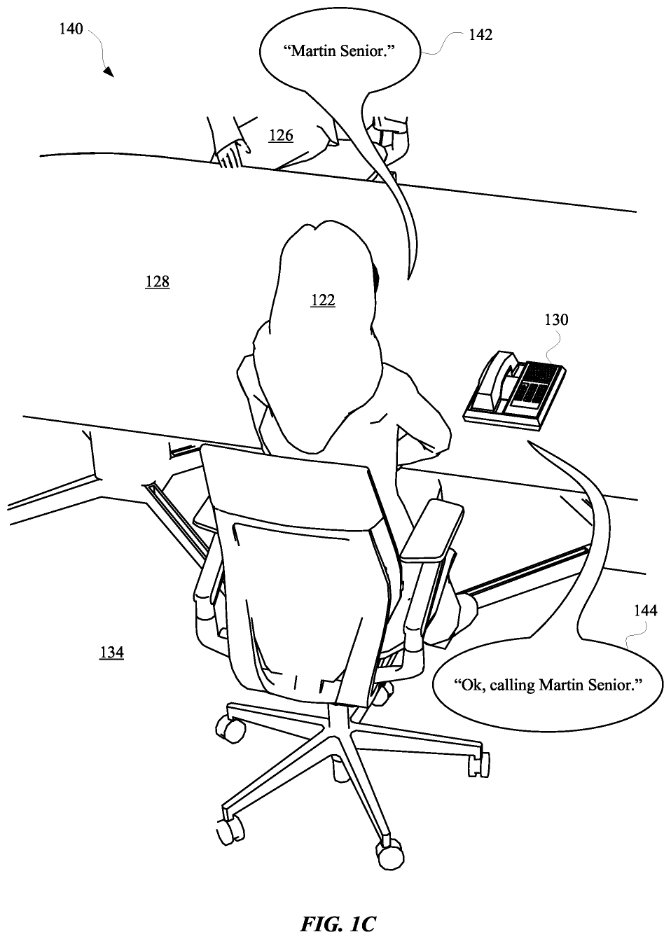

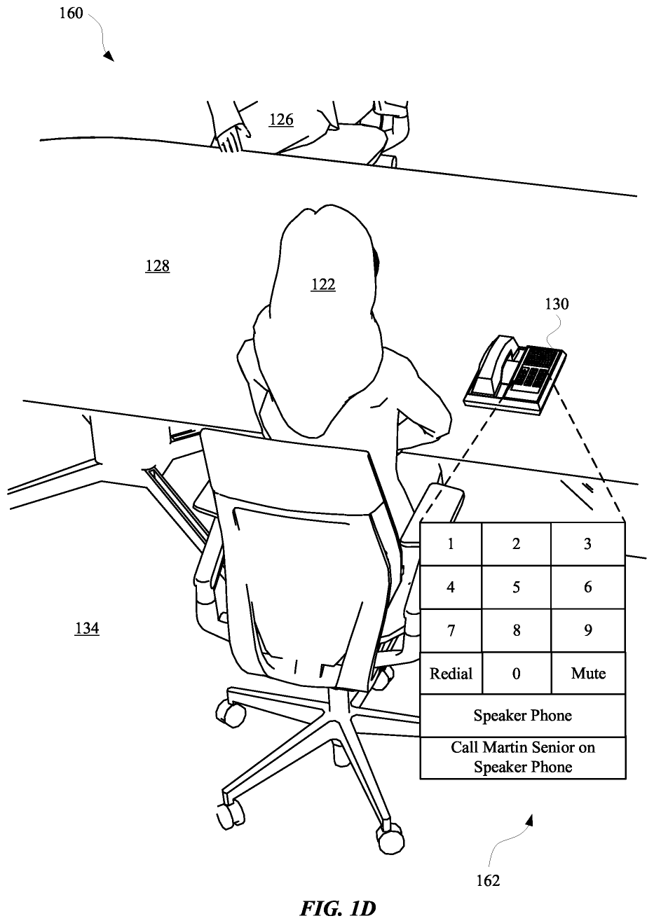

FIG. 1A, FIG. 1B, FIG. 1C, and FIG. 1D illustrate a view 100, a view 120, a view 140, and a view 160 of a user 102 interacting with an automated assistant application that can be responsive to virtual feature interactions while the user 102 is accessing a virtual environment 134. For example, the user 102 can be accessing the virtual environment 134 via a computing device 104, such as a wearable VR headset or computerized glasses. The virtual environment 134 can be rendered at a display interface of the computing device 104 by a virtual environment application that is provided by a third party entity (e.g., a first entity) relative to an entity (e.g., a second entity) that provides the automated assistant application and/or one or more other applications that the user 102 may access. The user 102 can be in a physical environment 106, such as their home living room, when accessing the virtual environment, and the physical environment can include other devices (e.g., a display device 112, a speaker device 110, a smart television 108, etc.) that can be connected to the same network as a network of the computing device 104. In this way, the automated assistant application can be accessible via each device in the physical environment.

In some implementations, an avatar 122 can represent the user 102 in the virtual environment 134, thereby allowing the user 102 to interact with virtual objects and virtual features of the virtual environment 134 through their avatar 122. For example, the user 102 can access the virtual environment 134 to participate in a meeting in which the avatar 122 of the user 102 can sit at a table 128 with another avatar 126 of a different user. In some implementations, virtual objects in the virtual environment 134 can include virtual features that the user 102 can interact with via their avatar 122, and an automated assistant application can be responsive to such interactions. The automated assistant application can interact with the virtual environment application via an API or other software interface, thereby allowing the automated assistant application to detect how the user 102 is interacting with the virtual environment 134, with prior permission from the user 102.

For example, the virtual environment 134 can include a virtual object 130 such as a virtual phone that can include virtual features 132. The virtual object 130 can be generated by the virtual environment application and/or another application that is separate from the automated assistant application. In some implementations, when the user 102 employs their avatar 122 to interact with the virtual features 132, the automated assistant application can process data characterizing the interaction in furtherance of assisting the user 102. For example, a virtual hand 136 of the avatar 122 can activate a “Speaker Phone” button of the virtual features 132 and, in response, the automated assistant application can initialize warm word detection for detecting warm words associated with phones and/or phone calls. Alternatively, or additionally, the automated assistant application can cause an output interface of the computing device 104 to render a responsive output to the user 102 interacting with the virtual features 132, such as a “ring tone” 124 or other audible sound to indicate that the user 102 invoked the automated assistant application.

In some implementations, the virtual features 132 may not be available at the virtual object 130 until the user 102 views the virtual object 130, their avatar 122 is within a threshold distance of the virtual object 130, the virtual object 130 is within a field of view of the avatar 122 within a most recent threshold duration of time, the virtual object 130 is within a threshold distance of the avatar 122 within another most recent threshold duration of time, and/or the virtual object is in the same virtual space (e.g., the same room) as the user. When the virtual features 132 are available for the user 102 to interact with, the automated assistant application can be responsive to interactions with the virtual features 132 and/or can cache operation data in anticipation of the user providing a warm word to initialize an operation corresponding to a virtual feature. For example, when the user 102 selects the “Speaker Phone” virtual feature 132 or otherwise views or motions near the “Speaker Phone” virtual feature 132, warm word detection of the automated assistant application can be activated for terms associated with phones and/or phone calls. As a result, the automated assistant application can be responsive to spoken utterances from the user 102 that are independent of, or otherwise void of, any invocation phrase, such as “Ok, Assistant.”

As an example, and as illustrated in view 140 of FIG. 1C, the user 102 can provide a spoken utterance 142 such as, “Martin Senior,” which can refer to a contact stored in a personal computing device of the user 102. The user 102 can provide the spoken utterance 142 to an audio input of the computing device 104, and the spoken utterance 142 can then be audibly rendered in the virtual environment 134. As a result, the other user associated with the other avatar 126 may also hear the spoken utterance 142 in their respective computing device. The automated assistant application can process audio data corresponding to the spoken utterance, while the automated assistant application is employing a warm word detection process. When the automated assistant application determines that the spoken utterance 142 includes a warm word (e.g., “Martin Senior”), the automated assistant application can identify one or more operations to initialize in response to the spoken utterance. For example, because the user 102 interacted with the “Speaker Phone” button of the virtual object 130, and thereafter provided the name of a contact, the automated assistant application can initialize a phone call operation with a parameter that includes a phone number for the identified contact.

In some implementations, the automated assistant application can determine that the user 102 habitually interacts with the virtual object 130 and/or the virtual features 132 to invoke the automated assistant application to perform a particular operation having one or more particular parameters. Based on this determination, the automated assistant application can generate an additional virtual feature 162 as a “shortcut” for that particular operation, and render the additional virtual feature 162 at, or otherwise in association with, the virtual object 130. For example, the automated assistant application can cause the additional virtual feature 162 to be rendered with, or in place of, the virtual features 132 illustrated in FIG. 1D. In some implementations, when the user 102 interacts with the additional virtual feature 162 in the virtual environment 134, the automated assistant application can cause a phone call to be initialized within the virtual environment 134 such that the other avatar 126 and other user can hear the phone call, with prior permission from the user 102. Alternatively, or additionally, the automated assistant application can cause one or more other devices (e.g., the speaker device 110) in the physical environment of the user 102 to also render the audio for the phone call, or otherwise render an output, in response to the user 102 interacting with the additional virtual feature 162.

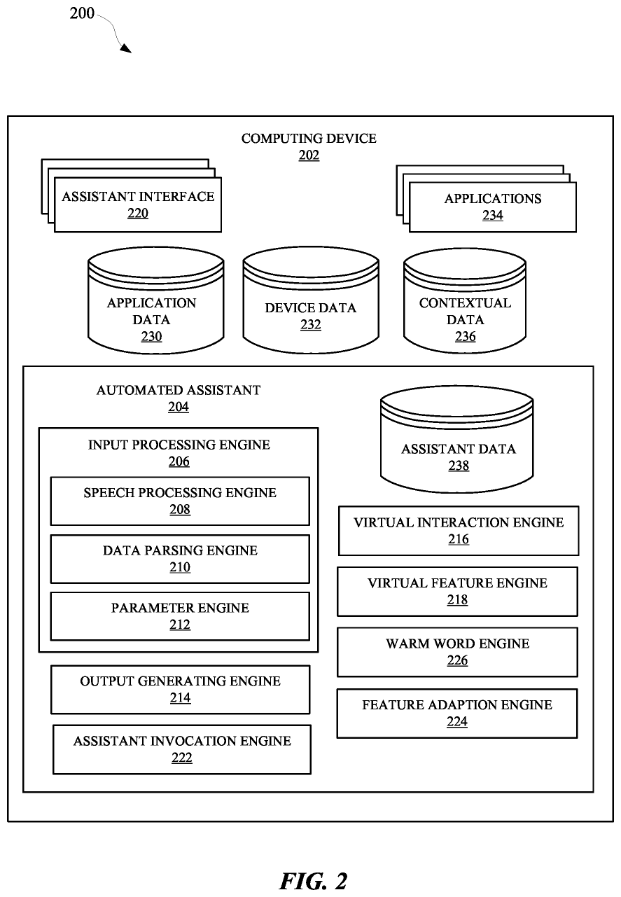

FIG. 2 illustrates a system 200 for providing an automated assistant 204 that can be responsive to a user that is accessing a virtual environment and can render virtual features in the virtual environment for facilitating further interactions with the automated assistant 204. The automated assistant 204 can operate as part of an assistant application that is provided at one or more computing devices, such as a computing device 202 and/or a server device. A user can interact with the automated assistant 204 via assistant interface(s) 220, which can be a microphone, a camera, a touch screen display, a user interface, and/or any other apparatus capable of providing an interface between a user and an application. For instance, a user can initialize the automated assistant 204 by providing a verbal, textual, and/or a graphical input to an assistant interface 220 to cause the automated assistant 204 to initialize one or more actions (e.g., provide data, control a peripheral device, access an agent, generate an input and/or an output, etc.). Alternatively, the automated assistant 204 can be initialized based on processing of contextual data 236 using one or more trained machine learning models. The contextual data 236 can characterize one or more features of an environment in which the automated assistant 204 is accessible, and/or one or more features of a user that is predicted to be intending to interact with the automated assistant 204. The computing device 202 can include a display device, which can be a display panel that includes a touch interface for receiving touch inputs and/or gestures for allowing a user to control applications 234 of the computing device 202 via the touch interface. In some implementations, the computing device 202 can lack a display device, thereby providing an audible user interface output, without providing a graphical user interface output. Furthermore, the computing device 202 can provide a user interface, such as a microphone, for receiving spoken natural language inputs from a user. In some implementations, the computing device 202 can include a touch interface and can be void of a camera, but can optionally include one or more other sensors.

The computing device 202 and/or other third party client devices can be in communication with a server device over a network, such as the internet. Additionally, the computing device 202 and any other computing devices can be in communication with each other over a local area network (LAN), such as a Wi-Fi network. The computing device 202 can offload computational tasks to the server device in order to conserve computational resources at the computing device 202. For instance, the server device can host the automated assistant 204, and/or computing device 202 can transmit inputs received at one or more assistant interfaces 220 to the server device. However, in some implementations, the automated assistant 204 can be hosted at the computing device 202, and various processes that can be associated with automated assistant operations can be performed at the computing device 202.

In various implementations, all or less than all aspects of the automated assistant 204 can be implemented on the computing device 202. In some of those implementations, aspects of the automated assistant 204 are implemented via the computing device 202 and can interface with a server device, which can implement other aspects of the automated assistant 204. The server device can optionally serve a plurality of users and their associated assistant applications via multiple threads. In implementations where all or less than all aspects of the automated assistant 204 are implemented via computing device 202, the automated assistant 204 can be an application that is separate from an operating system of the computing device 202 (e.g., installed “on top” of the operating system)—or can alternatively be implemented directly by the operating system of the computing device 202 (e.g., considered an application of, but integral with, the operating system).

In some implementations, the automated assistant 204 can include an input processing engine 206, which can employ multiple different modules for processing inputs and/or outputs for the computing device 202 and/or a server device. For instance, the input processing engine 206 can include a speech processing engine 208, which can process audio data received at an assistant interface 220 to identify the text embodied in the audio data. The audio data can be transmitted from, for example, the computing device 202 to the server device in order to preserve computational resources at the computing device 202. Additionally, or alternatively, the audio data can be exclusively processed at the computing device 202.

The process for converting the audio data to text can include a speech recognition algorithm, which can employ neural networks, and/or statistical models for identifying groups of audio data corresponding to words or phrases. The text converted from the audio data can be parsed by a data parsing engine 210 and made available to the automated assistant 204 as textual data that can be used to generate and/or identify command phrase(s), intent(s), action(s), slot value(s), and/or any other content specified by the user. In some implementations, output data provided by the data parsing engine 210 can be provided to a parameter engine 212 to determine whether the user provided an input that corresponds to a particular intent, action, and/or routine capable of being performed by the automated assistant 204 and/or an application or agent that is capable of being accessed via the automated assistant 204. For example, assistant data 238 can be stored at the server device and/or the computing device 202, and can include data that defines one or more actions capable of being performed by the automated assistant 204, as well as parameters necessary to perform the actions. The parameter engine 212 can generate one or more parameters for an intent, action, and/or slot value, and provide the one or more parameters to an output generating engine 214. The output generating engine 214 can use the one or more parameters to communicate with an assistant interface 220 for providing an output to a user, and/or communicate with one or more applications 234 for providing an output to one or more applications 234.

In some implementations, the automated assistant 204 can be an application that can be installed “on-top of” an operating system of the computing device 202 and/or can itself form part of (or the entirety of) the operating system of the computing device 202. The automated assistant application includes, and/or has access to, on-device speech recognition, on-device natural language understanding, and on-device fulfillment. For example, on-device speech recognition can be performed using an on-device speech recognition module that processes audio data (detected by the microphone(s)) using an end-to-end speech recognition machine learning model stored locally at the computing device 202. The on-device speech recognition generates recognized text for a spoken utterance (if any) present in the audio data. Also, for example, on-device natural language understanding (NLU) can be performed using an on-device NLU module that processes recognized text, generated using the on-device speech recognition, and optionally contextual data, to generate NLU data.

NLU data can include intent(s) that correspond to the spoken utterance and optionally parameter(s) (e.g., slot values) for the intent(s). On-device fulfillment can be performed using an on-device fulfillment module that utilizes the NLU data (from the on-device NLU), and optionally other local data, to determine action(s) to take to resolve the intent(s) of the spoken utterance (and optionally the parameter(s) for the intent). This can include determining local and/or remote responses (e.g., answers) to the spoken utterance, interaction(s) with locally installed application(s) to perform based on the spoken utterance, command(s) to transmit to internet-of-things (IoT) device(s) (directly or via corresponding remote system(s)) based on the spoken utterance, and/or other resolution action(s) to perform based on the spoken utterance. The on-device fulfillment can then initiate local and/or remote performance/execution of the determined action(s) to resolve the spoken utterance.

In various implementations, remote speech processing, remote NLU, and/or remote fulfillment can at least selectively be utilized. For example, recognized text can at least selectively be transmitted to remote automated assistant component(s) for remote NLU and/or remote fulfillment. For instance, the recognized text can optionally be transmitted for remote performance in parallel with on-device performance, or responsive to failure of on-device NLU and/or on-device fulfillment. However, on-device speech processing, on-device NLU, on-device fulfillment, and/or on-device execution can be prioritized at least due to the latency reductions they provide when resolving a spoken utterance (due to no client-server roundtrip(s) being needed to resolve the spoken utterance). Further, on-device functionality can be the only functionality that is available in situations with no or limited network connectivity.

In some implementations, the computing device 202 can include one or more applications 234 which can be provided by a third-party entity that is different from an entity that provided the computing device 202 and/or the automated assistant 204. An application state engine of the automated assistant 204 and/or the computing device 202 can access application data 230 to determine one or more actions capable of being performed by one or more applications 234, as well as a state of each application of the one or more applications 234 and/or a state of a respective device that is associated with the computing device 202. A device state engine of the automated assistant 204 and/or the computing device 202 can access device data 232 to determine one or more actions capable of being performed by the computing device 202 and/or one or more devices that are associated with the computing device 202. Furthermore, the application data 230 and/or any other data (e.g., device data 232) can be accessed by the automated assistant 204 to generate contextual data 236, which can characterize a context in which a particular application 234 and/or device is executing, and/or a context in which a particular user is accessing the computing device 202, accessing an application 234, and/or any other device or module.

While one or more applications 234 are executing at the computing device 202, the device data 232 can characterize a current operating state of each application 234 executing at the computing device 202. Furthermore, the application data 230 can characterize one or more features of an executing application 234, such as content of one or more graphical user interfaces being rendered at the direction of one or more applications 234. Alternatively, or additionally, the application data 230 can characterize an action schema, which can be updated by a respective application and/or by the automated assistant 204, based on a current operating status of the respective application. Alternatively, or additionally, one or more action schemas for one or more applications 234 can remain static, but can be accessed by the application state engine in order to determine a suitable action to initialize via the automated assistant 204.

The computing device 202 can further include an assistant invocation engine 222 that can use one or more trained machine learning models to process application data 230, device data 232, contextual data 236, and/or any other data that is accessible to the computing device 202. The assistant invocation engine 222 can process this data in order to determine whether or not to wait for a user to explicitly speak an invocation phrase to invoke the automated assistant 204, or consider the data to be indicative of an intent by the user to invoke the automated assistant—in lieu of requiring the user to explicitly speak the invocation phrase. For example, the one or more trained machine learning models can be trained using instances of training data that are based on scenarios in which the user is in an environment where multiple devices and/or applications are exhibiting various operating states. The instances of training data can be generated in order to capture training data that characterizes contexts in which the user invokes the automated assistant and other contexts in which the user does not invoke the automated assistant. When the one or more trained machine learning models are trained according to these instances of training data, the assistant invocation engine 222 can cause the automated assistant 204 to detect, or limit detecting, spoken invocation phrases from a user based on features of a context and/or an environment. Additionally, or alternatively, the assistant invocation engine 222 can cause the automated assistant 204 to detect, or limit detecting for one or more assistant commands from a user based on features of a context and/or an environment. In some implementations, the assistant invocation engine 222 can be disabled or limited based on the computing device 202 detecting an assistant suppressing output from another computing device. In this way, when the computing device 202 is detecting an assistant suppressing output, the automated assistant 204 will not be invoked based on contextual data 236—which would otherwise cause the automated assistant 204 to be invoked if the assistant suppressing output was not being detected.

In some implementations, the system 200 can include a virtual interaction engine 216 that can determine, with prior permission from a user, whether the user is accessing or otherwise interacting with a virtual environment. The automated assistant 204 can interact with the virtual environment using an API or other software interface that allows the automated assistant 204 to receive certain information from, and provide certain information to, the virtual environment. For example, the virtual interaction engine 216 can process data from the virtual environment for determining contextual data 236 for the virtual environment, such as any virtual objects and/or virtual features that are near, or within a viewing window, of an avatar of the user in the virtual environment. In some implementations, images and/or other data characterizing the features of the virtual environment can be processed by the virtual interaction engine 216 to determine operations that may be associated with features of the virtual environment. For example, when an avatar for a user is near a virtual kitchen in the virtual environment, the virtual interaction engine 216 can determine operations that may be associated with being in a kitchen, such as a setting a time, preheating an oven, accessing utensils, reading a recipe, and/or any other operation that can be associated with a kitchen.

In some implementations, the system 200 can further include a virtual feature engine 218, which can process data generated by the virtual interaction engine 216 and cause rendering of certain virtual features within the virtual environment. The data provided by the virtual interaction engine 216 can characterize operations that may be associated with a portion of the virtual environment that the user is accessing, and/or associated with recommendations for the user in a particular context. In some implementations, the virtual feature engine 218 can process the data using one or more heuristic processes and/or trained machine learning models to determine virtual features that should be rendered in the virtual environment. In particular, the data can be processed to determine the virtual features that will put the user on notice that, if the user interacts with the virtual features, they can cause the automated assistant to initialize and/or otherwise control certain application operations. For example, when the data characterizes an operation of reading a recipe, the virtual feature engine 218 can determine that a virtual cookbook should be rendered in the virtual environment for allowing the user to request that the automated assistant find a particular recipe. In some implementations, the virtual feature of a virtual cookbook can be selected based on prior interactions in a physical environment (e.g., a kitchen of the user's home) in which the user requested that the automated assistant perform similar operations. The virtual feature can then be selected from a database of virtual objects and/or virtual features, and/or generated using one or more heuristic processes and/or trained machine learning models that can iteratively generate virtual features.

In some implementations, the system 200 can include a warm word engine 226 that can activate warm word detection under certain conditions or in certain contexts when a user is accessing a virtual environment. For example, when an avatar representing the user is determined to be within a threshold distance of a virtual feature, warm word detection can be activated for warm words associated with that particular virtual feature. Alternatively, or additionally, when an avatar for the user is determined to be viewing a virtual feature, the warm word engine 226 can initialize warm word detection for detecting certain words associated with the virtual feature. When a particular word is detected, the automated assistant 204 can initialize an operation associated with the particular word, independent of whether the user provides an invocation phrase with the particular word. For example, when the user is viewing the virtual cookbook and provides the word “Spicy Chili,” the automated assistant 204 can respond by reciting a recipe for spicy chili in the virtual environment and/or open the virtual cookbook to a spicy chili recipe. In some implementations, other avatars for other users can also view the spicy chili recipe and/or listen to the automated assistant 204 recite the spicy chili recipe in response to the user providing the warm word. Alternatively, or additionally, another device in a physical environment of the user can also be controlled by the automated assistant and cause the spicy chili recipe to be rendered as audio in the physical environment of the user.

In some implementations, the system 200 can include a feature adaption engine 224 that can process historical interaction data associated with the user and the automated assistant 204, with prior permission from the user, to determine how to adapt certain virtual features over time. For example, a particular virtual feature can be utilized by a user to invoke the automated assistant 204 to perform an operation that has multiple different parameter values. As the user interacts with the particular virtual feature during different sessions of accessing the virtual environment, interaction data can indicate that the user typically only initializes the operation with a particular parameter. For example, when interacting with the virtual cookbook, the user may only invoke the automated assistant to recite the “Spicy Chili” recipe. The feature adaption engine 224 can process this interaction data and generate additional virtual feature data that can characterize an additional virtual feature, such as a virtual pamphlet that just includes the “Spicy Chili” recipe. The automated assistant 204 can cause the additional virtual feature to be rendered in the virtual environment in association with, or in place of, the virtual feature (e.g., the cookbook). Thereafter, when the user selects the additional virtual feature, the automated assistant 204 can respond by initializing the operation with the particular parameter (e.g., reciting the Spicy Chili recipe instead of asking the user to specify the recipe), without requesting that the user specify the particular parameter for the operation.

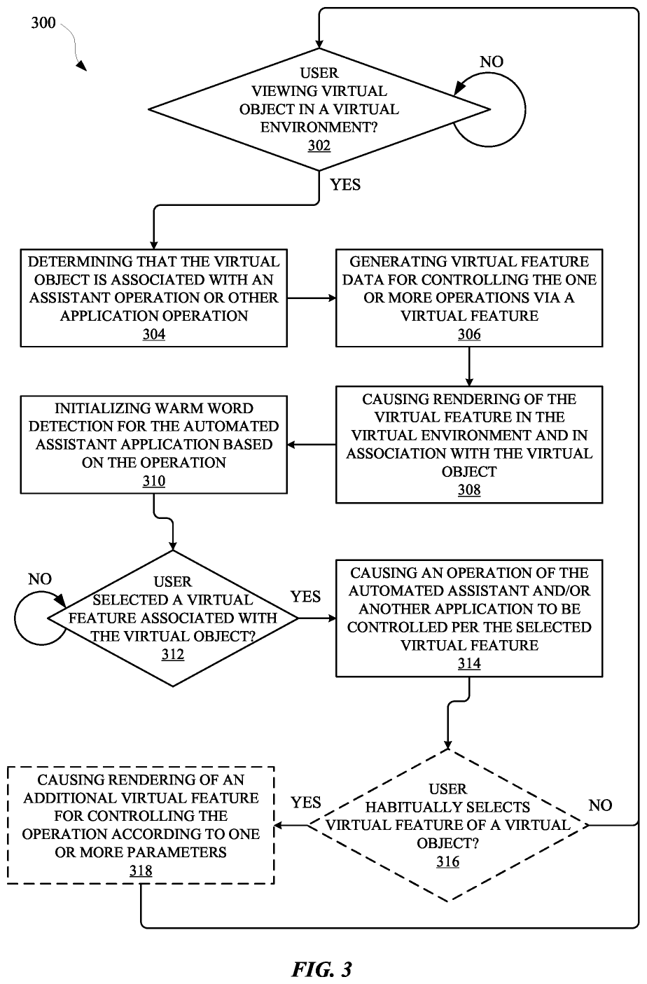

FIG. 3 illustrates a method 300 for providing a virtual feature for a virtual environment for controlling an operation of an automated assistant application and/or another application. The method 300 can be performed by one or more computing devices, applications, and/or any other apparatus or module that can be associated with an automated assistant. The method 300 can include an operation 302 of determining whether a user is viewing a virtual object in a virtual environment, such as a virtual environment that is accessible via a wearable VR headset or computerized glasses for viewing augmented reality. An automated assistant application can determine whether the user is viewing the virtual environment based on communications received from a virtual environment application, which can be an application that is provided by a third-party entity relative to an entity that provides the automated assistant application. For example, the automated assistant application can interact with the virtual environment application using an application programming interface (API).

When a user is determined to be viewing the virtual object in the virtual environment, the method 300 can proceed from the operation 302 to an operation 304. Otherwise, the automated assistant application can continue to operate to determine whether the user is interacting with any particular virtual objects in the virtual environment. The operation 304 can include determining that the virtual object is associated with an assistant operation or another application operation. For example, although the virtual object may not be directly generated, and/or otherwise provided, by the automated assistant application, the automated assistant application can determine whether the virtual object is associated with any operations that can be controlled by the automated assistant application or another application (e.g., an application that is different from the automated assistant application and the virtual environment application). The virtual object can be, but is not limited to, a virtual representation of an appliance or other device that the user has access to in their physical environment. As an example, the virtual object can be a virtual alarm clock and the automated assistant application can determine that the virtual alarm clock is associated with operations such as setting a timer, setting an alarm, determining the current time, and/or any other operation that can be associated with an alarm clock.

The method 300 can proceed from the operation 304 to an operation 306 of generating virtual feature data for controlling the one or more operations via a virtual feature to be rendered in the virtual environment. In some implementations, the virtual feature data can characterize multiple different virtual features that the user can interact with to control one or more particular operations associated with the virtual object. For example, the virtual feature data can characterize a button for setting a timer, another button for delaying an ongoing alarm, and/or yet another button for audibly rendering the time for another time zone. In some implementations, the virtual future data can be generated to avoid duplicating virtual features of the virtual object. Therefore, if the virtual object already has a particular virtual feature that the user can interact with to control an operation of the automated assistant or separate application, the virtual feature data can be generated to avoid duplicating any existing virtual features of the virtual object.

In some implementations, the virtual feature data can be generated to characterize one or more parameters that can be controlled by an existing virtual feature and/or a virtual feature that the automated assistant application causes to be rendered in the virtual environment. For example, the virtual feature data can characterize a button for setting a timer for 5 minutes, and therefore a parameter characterized by the virtual feature data can be a parameter or slot value representing “5” minutes. When the virtual feature is rendered in the virtual environment, the method 300 can proceed from the operation 308 to an operation 310. The operation 310 can include initializing warm word detection for the automated assistant application. When the automated assistant application is operating according to warm word detection, the automated assistant can respond to certain words independent of whether a user provides an invocation phrase to the automated assistant application. For example, when a user is viewing or otherwise interacting with the virtual feature for setting the timer, the user can provide a spoken utterance such as, “Five minutes.” In response to the spoken utterance, the automated system can set the timer for five minutes without the user providing any initial invocation phrase such as, “Assistant.”

The method 300 can proceed from the operation 310 to an operation 312, which can include determining whether the user selected the virtual feature associated with the virtual object. The user can select the virtual feature by providing a warm word associated with the virtual feature and/or by using an avatar, representing the user in a virtual environment, to interact with the virtual feature. For example, the user can provide an input to the virtual environment for causing a hand of the avatar to tap the virtual future and/or otherwise select the virtual feature. When the virtual feature is determined to have been selected, the method 300 can proceed from the operation 312 to an operation 314. Otherwise, the automated assistant application can await further input from the user.

The operation 314 can include causing an operation of the automated assistant and/or another application to be controlled per the selected virtual feature. For example, when the user provides a warm word to the automated assistant application to select the virtual feature, the automated assistant application can cause a corresponding operation to be initialized by the automated assistant application and/or a separate application. In some implementations, the virtual object can be provided by a third-party entity relative to the automated assistant application and the virtual environment application, and the virtual feature can be generated by the automated assistant application and incorporated into the virtual environment using an API. Therefore, when the user selects the virtual feature, the automated assistant can identify one or more parameters associated with the virtual feature and initialize the third-party application provided by the third-party entity. The third party application can be initialized to perform the operation according to the one or more parameters associated with a virtual feature. For example, when the user provides the warm word “5 minutes” and the virtual object is an alarm clock provided by a third-party application, the automated assistant application can initialize the third-party application to set a timer for 5 minutes.

The method 300 can optionally proceed from the operation 314 to an operation 316, which will include determining whether the user habitually selects the virtual feature of the virtual object. In some implementations, the operation 316 can be determined by processing historical interaction data that can indicate how frequently and/or under what circumstances the user interacts with a virtual feature, with prior permission from the user. Alternatively, or additionally, the automated assistant application can determine, with prior permission from the user, in what context the user typically interacts with the one or more virtual features. In such instances, when the user is determined to habitually interact with the virtual future, the method 300 can proceed from the operation 316 to an operation 318. Otherwise, the method 300 can return to the operation 302. The operation 318 can include causing rendering of an additional virtual feature for controlling the operation according to the one or more parameters that the user has habitually utilized upon selecting the virtual feature. For example, if a user is determined to habitually interact with the virtual future and thereafter provide the same warm word each time, the additional virtual feature that is generated can be provided to also select the parameter corresponding to the warm word when a user interacts with the additional virtual feature. In other words, a selection of the additional virtual feature can cause the automated assistant application to initialize performance of the operation according to the parameter that the user has typically selected by warm word and/or by any other input to the automated assistant application and/or the virtual environment.

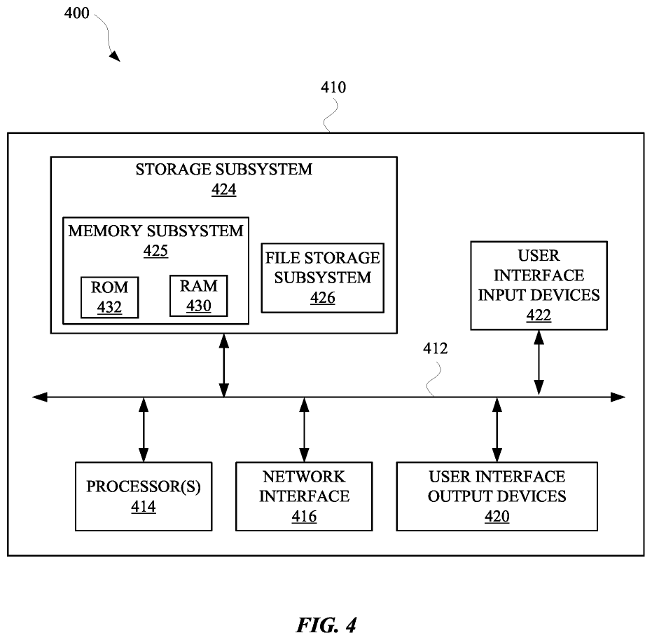

FIG. 4 is a block diagram 400 of an example computer system 410. Computer system 410 typically includes at least one processor 414 which communicates with a number of peripheral devices via bus subsystem 412. These peripheral devices may include a storage subsystem 424, including, for example, a memory 425 and a file storage subsystem 426, user interface output devices 420, user interface input devices 422, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to perform selected aspects of method 300, and/or to implement one or more of system 200, automated assistant, computing device 104, and/or any other application, device, apparatus, and/or module discussed herein.

These software modules are generally executed by processor 414 alone or in combination with other processors. Memory 425 used in the storage subsystem 424 can include a number of memories including a main random access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In some implementations, a method implemented by one or more processors is set forth as including operations such as determining, by an automated assistant application, that a user is viewing a portion of a virtual environment that includes a virtual object. The user views the virtual environment via a display interface of a computing device. The method can further include determining, based on the virtual object, that the virtual object is associated with one or more operations that are capable of being controlled via the automated assistant application and/or via a separate application. The method can further include generating, based on the one or more operations associated with the virtual object, virtual feature data that characterizes a virtual feature for controlling the one or more operations when the user interacts with the virtual feature via the virtual environment. The method can further include causing, based on the virtual feature data and by the automated assistant application, rendering of the virtual feature in the virtual environment. Causing the rendering of the virtual feature can include causing the virtual feature to be rendered at a location, within the virtual environment, that is associated with the virtual object. The method can further include, in response to determining that the user interacted with the virtual feature via the virtual environment: causing the automated assistant to control the one or more operations of the automated assistant application and/or the separate application according to an interaction between the user and the virtual feature.

In some implementations, causing rendering of the virtual feature in the virtual environment causes the virtual feature to be rendered at a separate display interface of a separate computing device of another user who is viewing the location within the virtual environment. In some implementations, generating the virtual feature data that characterizes the virtual feature includes determining textual content to include with the virtual feature, where the textual content indicates the one or more operations that can be controlled by interacting with the virtual feature. In some implementations, the interaction with the virtual feature includes the user providing a spoken utterance to the automated assistant application while the user is viewing the virtual feature via the display interface of the computing device, and the spoken utterance describes the textual content without providing any invocation phrase for the automated assistant application. In some implementations, generating the virtual feature data that characterizes the virtual feature includes determining textual content to include with the virtual feature, where the textual content indicates the separate application that can be controlled by interacting with the virtual feature.

In some implementations, the method can further include causing, based on the virtual feature data, the automated assistant application to initialize warm word detection for one or more particular spoken words. The warm word detection causes the automated assistant application to monitor for occurrence of speaking of the one or more particular spoken words, independent of detecting an invocation phrase, and to control the one or more operations in response to detecting, during monitoring for the occurrence, of speaking of the one or more particular spoken words. In some implementations, causing the automated assistant application to initialize the warm word detection for the one or more particular spoken words is performed further based on the virtual object being rendered within a field of view of the user while the user is accessing the virtual environment. In some implementations, the virtual environment includes an avatar that represents a position of the user within the virtual environment, and causing the automated assistant to initialize the warm word detection for the one or more particular spoken words is performed further based on the virtual object being within a threshold distance of the avatar for the user. In some implementations, the virtual environment includes an avatar that represents a position of the user within the virtual environment, and causing the automated assistant to initialize warm word detection for the one or more particular spoken words is performed further based on the virtual object being within a threshold distance of the avatar for the user, and/or within a field of view of the user, during a most recent threshold duration of time.

In other implementations, a method implemented by one or more processors is set forth as including operations such as determining, by an automated assistant application, that a user has selected a virtual feature of a virtual environment via an interface of a computing device. The user accesses the virtual environment by viewing a display interface of the computing device. The method can further include determining, based on the user selecting the virtual feature, one or more parameters for one or more operations that can be controlled by interacting with the virtual feature in the virtual environment, where the one or more operations are performed by the automated assistant application and/or a separate application. The method can further include causing, based on the one or more parameters and the virtual feature, the automated assistant application to initialize warm word detection. The warm word detection causes the automated assistant application to be responsive to one or more particular spoken words characterizing the one or more parameters without detecting an invocation phrase for the automated assistant application. The method can further include determining, when the automated assistant application is operating the warm word detection, that the user has provided a spoken utterance that includes a particular word of the one or more particular spoken words. The particular word corresponds to a particular parameter of the one or more parameters. The method can further include causing, in response to the user providing the spoken utterance, to initialize performance of the one or more operations according to the particular parameter corresponding to the particular word spoken by the user.

In some implementations, determining that the user has selected the virtual feature of the virtual environment via the interface of the computing device includes determining that an avatar for the user in the virtual environment is within a threshold distance of the virtual feature in the virtual environment. In some implementations, determining that the user has selected the virtual feature of the virtual environment via the interface of the computing device includes determining that the virtual feature has been within a field of view of the user for at least a most recent threshold duration of time. In some implementations, the method can further include, prior to determining that the user has selected the virtual feature of the virtual environment, causing the automated assistant application to cache operation data for initializing execution of the one or more operations, where the operation data is cached in response to the virtual feature being within a field of view of the user. In some implementations, the method can further include, prior to determining that the user has selected the virtual feature of the virtual environment: causing the automated assistant application to cache operation data for initializing execution of the one or more operations, where the operation data is cached in response to the virtual feature being within a threshold distance of an avatar of the user within the virtual environment.

In yet other implementations, a method implemented by one or more processors is set forth as including operations such as determining, by an automated assistant application, that a user has selected a virtual feature of a virtual environment in furtherance of controlling an operation of the automated assistant application and/or a separate application. The user accesses the virtual environment by viewing a display interface of a computing device. The method can further include determining, by the automated assistant application, that the user has selected one or more parameters for the operation, where the user selects the one or more parameters by further interacting with the automated assistant and/or further interacting with the virtual environment. The method can further include determining, based on the user selecting the one or more parameters, that the user has previously selected the one or more parameters for the operation during a prior interaction between the user and the automated assistant application. The method can further include generating, based on the user having previously selected the one or more parameters during the prior interaction between the user and the automated assistant application, virtual feature data. The virtual feature data characterizes an additional virtual feature that can be rendered in the virtual environment with, or to replace, the virtual feature. The method can further include causing, by the automated assistant application and based on the virtual feature data, rendering of the additional virtual feature in the virtual environment. A selection of the additional feature causes the automated assistant application to initialize performance of the operation in accordance with the one or more parameters previously selected by the user.

In some implementations, determining that the user has selected the one or more parameters for the operation includes: determining that the user has directed a spoken utterance to the automated assistant application, and that the spoken utterance includes a warm word characterizing the one or more parameters. The spoken utterance is independent of any invocation phrase for the automated assistant application. In some implementations, the additional virtual feature includes virtual content that characterizes the one or more parameters, and the virtual feature does not include the virtual content. In some implementations, causing rendering of the additional virtual feature in the virtual environment includes: causing the additional virtual feature to be rendered on a virtual surface of a virtual object that is provided by the separate application, and the operation is performed by the separate application. An entity that provides the separate application is different from a first entity that provides the automated assistant and also different from a second entity that provides the virtual environment. In some implementations, performance of the operation includes causing an output interface of a separate computing device in a physical environment of the user to render audio and/or visual output. In some implementations, the method can further include causing, in response to a separate user selecting the additional virtual feature, a separate instance of the automated assistant application to initialize execution of the operation for the separate user.

We claim:

1. A method implemented by one or more processors, the method comprising:
determining, by an automated assistant application, that a user is viewing a portion of a virtual environment that includes a virtual object,
wherein the user views the virtual environment via a display interface of a computing device;
determining, based on the virtual object, that the virtual object is associated with one or more operations that are capable of being controlled via the automated assistant application and/or via a separate application;
generating, based on the one or more operations associated with the virtual object, virtual feature data that characterizes a virtual feature for controlling the one or more operations when the user interacts with the virtual feature via the virtual environment;
causing, based on the virtual feature data and by the automated assistant application, rendering of the virtual feature in the virtual environment,
wherein the virtual feature is rendered at a location within the virtual environment that is associated with the virtual object; and
in response to determining that the user interacted with the virtual feature via the virtual environment:
causing the automated assistant to control the one or more operations of the automated assistant application and/or the separate application according to an interaction between the user and the virtual feature.

2. The method of claim 1, wherein causing rendering of the virtual feature in the virtual environment causes the virtual feature to be rendered at a separate display interface of a separate computing device of another user who is viewing the location within the virtual environment.

3. The method of claim 1, wherein generating the virtual feature data that characterizes the virtual feature includes:
determining textual content to include with the virtual feature,
wherein the textual content indicates the one or more operations that can be controlled by interacting with the virtual feature.

4. The method of claim 1,
wherein the interaction with the virtual feature includes the user providing a spoken utterance to the automated assistant application while the user is viewing the virtual feature via the display interface of the computing device, and
wherein the spoken utterance describes the textual content without providing any invocation phrase for the automated assistant application.

5. The method of claim 1, wherein generating the virtual feature data that characterizes the virtual feature includes:
determining textual content to include with the virtual feature,
wherein the textual content indicates the separate application that can be controlled by interacting with the virtual feature.

6. The method of claim 1, further comprising:
causing, based on the virtual feature data, the automated assistant application to initialize warm word detection for one or more particular spoken words,
wherein the warm word detection causes the automated assistant application to monitor for occurrence of speaking of the one or more particular spoken words,
independent of detecting an invocation phrase, and to control the one or more operations in response to detecting, during monitoring for the occurrence, of speaking of the one or more particular spoken words.

7. The method of claim 6, wherein causing the automated assistant application to initialize the warm word detection for the one or more particular spoken words is performed further based on the virtual object being rendered within a field of view of the user while the user is accessing the virtual environment.

8. The method of claim 6,
wherein the virtual environment includes an avatar that represents a position of the user within the virtual environment, and
wherein causing the automated assistant to initialize the warm word detection for the one or more particular spoken words is performed further based on the virtual object being within a threshold distance of the avatar for the user.

9. The method of claim 6,
wherein the virtual environment includes an avatar that represents a position of the user within the virtual environment, and
wherein causing the automated assistant to initialize warm word detection for the one or more particular spoken words is performed further based on the virtual object being within a threshold distance of the avatar for the user, and/or within a field of view of the user, during a most recent threshold duration of time.

10. A method implemented by one or more processors, the method comprising:
determining, by an automated assistant application, that a user has selected a virtual feature of a virtual environment via an interface of a computing device,
wherein the user accesses the virtual environment by viewing a display interface of the computing device;
determining, based on the user selecting the virtual feature, one or more parameters for one or more operations that can be controlled by interacting with the virtual feature in the virtual environment,
wherein the one or more operations are performed by the automated assistant application and/or a separate application;
causing, based on the one or more parameters and the virtual feature, the automated assistant application to initialize warm word detection,
wherein the warm word detection causes the automated assistant application to be responsive to one or more particular spoken words characterizing the one or more parameters without detecting an invocation phrase for the automated assistant application;
determining, when the automated assistant application is operating the warm word detection, that the user has provided a spoken utterance that includes a particular word of the one or more particular spoken words,
wherein the particular word corresponds to a particular parameter of the one or more parameters; and
causing, in response to the user providing the spoken utterance, to initialize performance of the one or more operations according to the particular parameter corresponding to the particular word spoken by the user.

11. The method of claim 10, wherein determining that the user has selected the virtual feature of the virtual environment via the interface of the computing device includes:
determining that an avatar for the user in the virtual environment is within a threshold distance of the virtual feature in the virtual environment.

12. The method of claim 10, wherein determining that the user has selected the virtual feature of the virtual environment via the interface of the computing device includes:
determining that the virtual feature has been within a field of view of the user for at least a most recent threshold duration of time.

13. The method of claim 10, further comprising:
prior to determining that the user has selected the virtual feature of the virtual environment:
causing the automated assistant application to cache operation data for initializing execution of the one or more operations,
wherein the operation data is cached in response to the virtual feature being within a field of view of the user.

14. The method of claim 10, further comprising:
prior to determining that the user has selected the virtual feature of the virtual environment:
causing the automated assistant application to cache operation data for initializing execution of the one or more operations,
wherein the operation data is cached in response to the virtual feature being within a threshold distance of an avatar of the user within the virtual environment.

15. A method implemented by one or more processors, the method comprising:
determining, by an automated assistant application, that a user has selected a virtual feature of a virtual environment in furtherance of controlling an operation of the automated assistant application and/or a separate application,
wherein the user accesses the virtual environment by viewing a display interface of a computing device;
determining, by the automated assistant application, that the user has selected one or more parameters for the operation,
wherein the user selects the one or more parameters by further interacting with the automated assistant and/or further interacting with the virtual environment;
determining, based on the user selecting the one or more parameters, that the user has previously selected the one or more parameters for the operation during a prior interaction between the user and the automated assistant application;
generating, based on the user having previously selected the one or more parameters during the prior interaction between the user and the automated assistant application, virtual feature data,
wherein the virtual feature data characterizes an additional virtual feature that can be rendered in the virtual environment with, or to replace, the virtual feature; and
causing, by the automated assistant application and based on the virtual feature data, rendering of the additional virtual feature in the virtual environment,
wherein a selection of the additional feature causes the automated assistant application to initialize performance of the operation in accordance with the one or more parameters previously selected by the user.

16. The method of claim 15, wherein determining that the user has selected the one or more parameters for the operation includes:
determining that the user has directed a spoken utterance to the automated assistant application, and that the spoken utterance includes a warm word characterizing the one or more parameters,
wherein the spoken utterance is independent of any invocation phrase for the automated assistant application.

17. The method of claim 15, wherein the additional virtual feature includes virtual content that characterizes the one or more parameters, and the virtual feature does not include the virtual content.

18. The method of claim 15, wherein causing rendering of the additional virtual feature in the virtual environment includes:
causing the additional virtual feature to be rendered on a virtual surface of a virtual object that is provided by the separate application, and the operation is performed by the separate application,
wherein an entity that provides the separate application is different from a first entity that provides the automated assistant and also different from a second entity that provides the virtual environment.

19. The method of claim 15, wherein performance of the operation includes causing an output interface of a separate computing device in a physical environment of the user to render audio and/or visual output.

20. The method of claim 15, further comprising:
causing, in response to a separate user selecting the additional virtual feature, a separate instance of the automated assistant application to initialize execution of the operation for the separate user.
